(19) United States
(12) Patent Application Publication
(10) Pub. No.: US 2001/0026780 A1
(43) Pub. Date: Oct. 4, 2001

(54) Housing for an exhaust gas catalyst

(75) Inventors: Georg Reuther, Hochstadt (DE); Reiner Helbig, Mutterstadt (DE); Jurgen Rickertsen, Lambrecht (DE)

Correspondence Address: Friedrich Kueffner, 342 Madison Avenue, Suite 1921, New York, NY, 10173, US

(73) Assignee: Heinrich Gillet GmbH & Co. KG

(21) Appl. No.: 09/821,492

(22) Filed: Mar. 29, 2001

(30) Foreign Application Priority Data
Apr. 1, 2000 (DE) 100 16 401.3

(51) Int. Cl. B01D 53/34

(52) U.S. Cl. 422/177; 422/180

(57) ABSTRACT

A housing for an exhaust gas catalyst in motor vehicles with an internal combustion engine has a first seamless housing part deep-drawn of sheet metal, wherein the first housing part has at least one inlet cone, at least one first pipe connector, and at least one first cylindrical housing mantle. A second seamless housing part deep-drawn of sheet metal has at least one outlet cone, at least one second pipe connector, and at least one second cylindrical housing mantle. The first and second housing mantles are connected to one another by a gas-tight peripheral connecting seam.

### BACKGROUND OF THE INVENTION

1. Field of the Invention

The invention relates to a housing for exhaust gas catalysts in motor vehicles with internal combustion engines, wherein the housing comprises at least two housing parts that are deep-drawn from sheet metal, wherein each housing part has at least one inlet cone or outlet cone, a pipe connector, and a housing mantle, and wherein a gas-tight connecting seam connects the housing parts.

2. Description of the Related Art

Worldwide, it has been known for many years to employ exhaust gas catalysts for the removal of pollutants from the exhaust gases of combustion processes. One of the most prominent application fields is the automotive industry, where exhaust gas catalysts are used for internal combustion engines of the spark ignition type as well as the diesel type. The housings of such exhaust gas catalyst are comprised of formed sheet metal. In this connection, several basic manufacturing technologies are used.

A first manufacturing technology is the so-called winding technology (DE 32 09 211 A). In this connection, a sheet metal is wound about the catalyst support for manufacturing the housing mantle. Subsequently, the inlet and outlet cones are welded to the housing mantle. A disadvantage of this type of housing is that, during manufacture of the welding seams, the sheet metal can warp and thus exert unilateral forces onto the catalyst support. Moreover, it is a disadvantage that the welding seams during operation of the catalyst are thermally highly loaded.

Another housing type uses deep-drawn sheet metal for producing semi-shells which are then placed about the catalyst support and are subsequently welded to one another (DE 73 01 454 U). This welding seam extends over the inlet cone, the housing mantle, the outlet cone, the other side of the housing mantle back toward the inlet cone, is relatively long and, in many cases, must be finished or completed by manual welding. In this configuration, parts of the welding seam are also highly thermally loaded. The important disadvantage of this housing configuration is however that, when pressing the semi-shells of the housing together for connecting them, the catalyst support can be easily damaged. However, this can be monitored only with difficulty after welding of the housing.

A third type of catalyst housing is completely without seams (DE 197 34 198 A). The starting material is a pipe whose cross-section is of such a size that the catalyst support can be inserted with precise fit. Subsequently, by the so-called hot rolling method, both projecting ends of the pipe are formed to inlet and outlet cones. The disadvantage of such a housing type is that the inlet and outlet cones as well as the pipe connectors to be provided thereat can be formed only in a coaxial arrangement. Moreover, the manufacture is relatively time-consuming.

### SUMMARY OF THE INVENTION

It is an object of the present invention to provide a catalyst housing which combines the advantages of the two last described housing types while eliminating their disadvantages.

In accordance with the present invention, this is achieved in that each housing part is free of seams, the housing mantles are substantially cylindrical, and the peripheral connecting seam connects the housing mantles.

Such a housing has several advantages. First, welding seams within the temperature-critical and strength-critical areas, for example, in the area of the inlet or outlet cone, are no longer present. The seam which connects the two housing parts to one another is located in an area of the housing mantle which is not critical in regard to the housing strength, it is short, and it can be produced in practically all situations by an automated welding device. Moreover, with a corresponding configuration of the housing parts, it can be positioned practically at any desired location, for example, where the heat produced during welding will not affect the catalyst support. Each housing part can receive a catalyst support wherein in any situation a secure placement of the support member in the housing part is achieved because the housing part will not change its shape. This also makes possible a safe cold storage of the support member.

A favorable, i.e., uniform, extension of the wall thickness and the minimal, or entirely missing, edges of the shells result in a weight optimization and more beneficial mounting conditions in comparison to conventional housing types of today.

Advantageously, the housing parts have cross-sections which are different from one another for producing a cascade-type catalyst. This makes it possible to position within one housing catalyst support members of different dimensions and to optimize the flow conditions. The housing parts must have the same cross-section only in the area of the connecting seam.

According to a further embodiment of the invention, a housing part has a stepped cylindrical cross-section. This makes possible an even better adaptation of the housing shapes to the spatial conditions in the motor vehicle.

According to a further development of the invention, several pipe connectors are provided on one of the cones. This embodiment is particularly suitable for catalysts mounted near the motor because this makes it possible to introduce the exhaust gas pipes coming from the cylinder outlet directly to the inlet cone of the catalyst housing.

Advantageously, the axis of at least one pipe connector is positioned at an angle to the axis of the housing mantle. This measure also serves for providing a flexible adaptation of the housing to the spatial conditions within the motor vehicle. It makes possible furthermore an optimization of the flow against the end face of the catalyst support.

Also, the cross-sections of the pipe connectors can be selected as desired, in particular, as required by the flow guiding conditions.

The additional feature, according to which the cones themselves do not have radial symmetry, acts in the same way.

At least one cone, conventionally the inlet cone, can have a flow-deflecting formed part.

Advantageously, a sensor connecting socket is formed in one of the housing parts in the area of the connecting seam. Such sensors are used in exhaust gas catalysts in order to monitor the catalytic activity.

According to a further embodiment of the invention, in the case of especially long catalyst housings an intermediate piece of any desired form can be inserted between the housing parts since the depth ratio obtainable by deep drawing is limited because of the material—if no very expensive and complex multi-step deep drawing process with intermediate annealing is used.

Advantageously, the inventive housing can be inserted into a heat-insulating outer housing. This outer housing is produced preferably in the same way as the inner housing.

Advantageously, the sheet material for producing, in particular, the inner housing is preferably stainless steel, even Inconel®. The thermally less loaded outer housing, on the other hand, can be comprised of a less expensive material.

Advantageously, the two housing parts can also be of identical configuration in order to take advantage of process simplifications when employing identical parts.

### BRIEF DESCRIPTION OF THE DRAWING

In the drawing:

FIG. 1 shows a first embodiment of a catalyst housing according to the invention;

FIG. 2 shows a second embodiment of a catalyst housing according to the invention;

FIG. 3 shows a third embodiment of a catalyst housing according to the invention;

FIG. 4 shows a fourth embodiment of a catalyst housing according to the invention, wherein an inner housing is inserted into an insulating outer housing.

### DESCRIPTION OF THE PREFERRED EMBODIMENTS

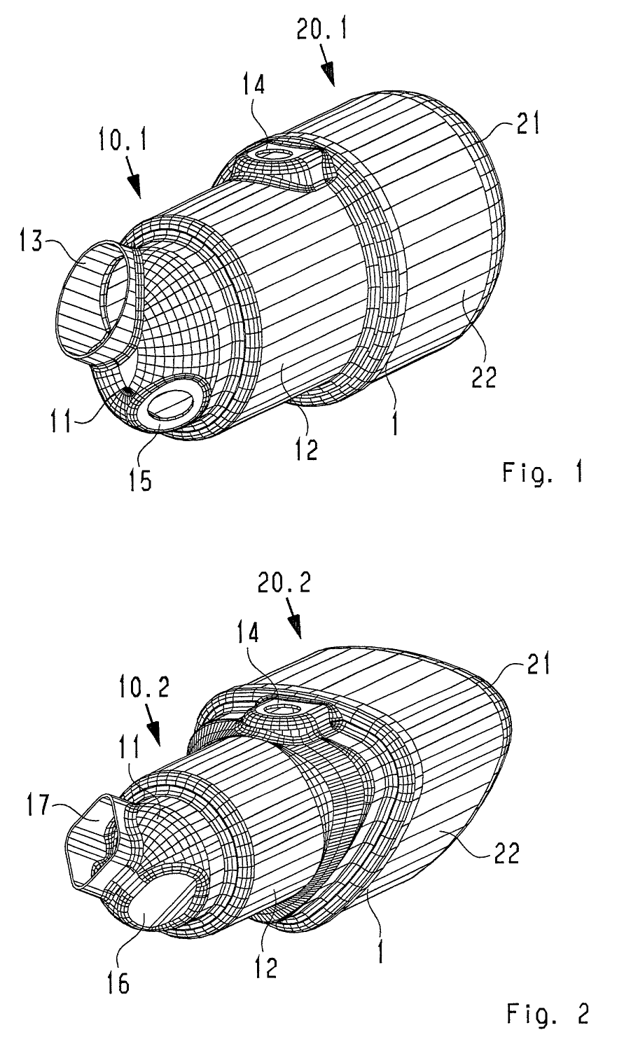

FIG. 1 shows a first catalyst housing. It is comprised of two housing parts 10.1, 20.1, each having an inlet cone 11, respectively, outlet cone 21, a pipe connector 13, and a cylindrical mantle 12, 22. The housing mantles 12, 22 are substantially cylindrical. Their cross-sections differ from one another.

Both housing mantles 12, 22 are connected to one another in a gas-tight way by a peripheral seam 1. This seam 1 is short and can be easily produced, if needed, by an automated closure or welding device. The seam 1 can be positioned at a location where it does not affect the catalyst supports mounted within the interior of the housing.

In the housing part 10.1 a connecting socket 14 for a lambda sensor is provided. This socket 14 is positioned in the area of the connecting seam 1 so that a sensor inserted here projects into the intermediate space between two catalyst supports arranged in the interior of the housing. Connecting sockets 15 can also be positioned at other locations, for example, at the inlet cone 11.

FIG. 2 shows a further catalyst housing according to the invention. The cross-section of the forward housing part 10.2 is circular, the cross-section of the rearward housing part 20.2, on the other hand, is of a tri-oval shape. The cross-sections of the two housing parts 10.2, 20.2 are identical only in the area of the connecting seam so that the connecting seam 1 can be gas-tight.

The inlet socket 11 is provided with a formed part 16 that provides flow deflection. Moreover, the pipe connector or socket 17 has a square cross-section.

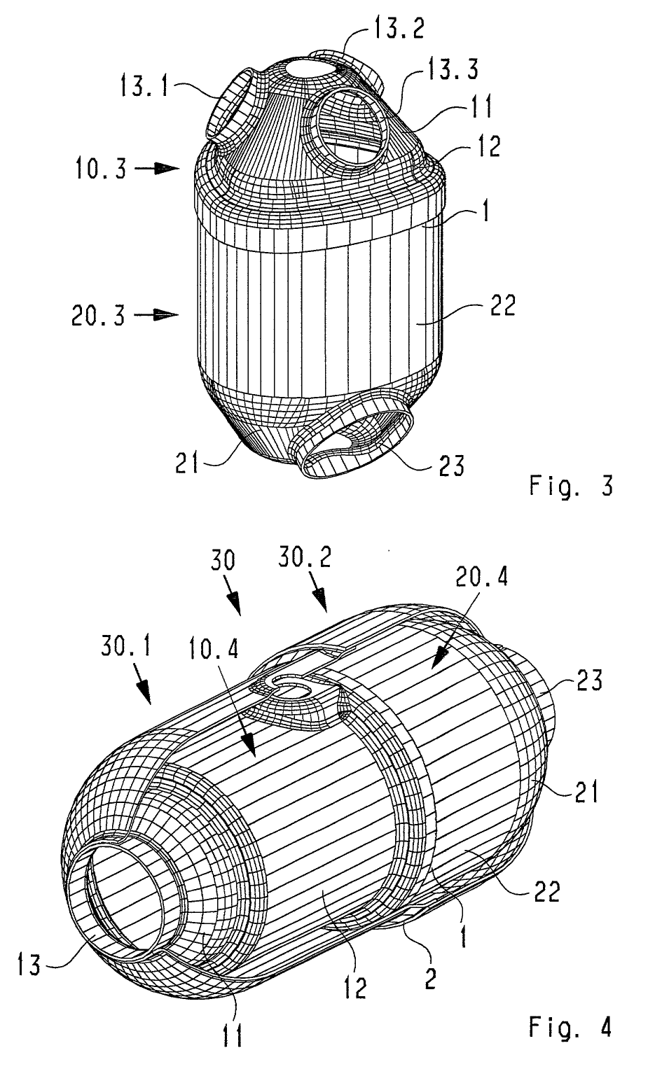

FIG. 3 shows a third embodiment. The first housing part 10.3 has an inlet cone 11 with three pipe connectors 13.1, 13.2, 13.3. The housing mantle 12 of the first housing part 10.3 is very short. The catalyst support is seated only in the second housing part 20.3 with the pipe connector 23. Such a housing is particularly suitable for a catalyst positioned near the motor because the pipes which come from the cylinder outlets can be directly inserted into the inlet sockets 11.

FIG. 4 shows a fourth embodiment of a housing according to the invention. The two housing parts 10.4, 20.4 have a circular cross-section, respectively. They are arranged in an insulating outer housing 30 whose housing parts 30.1, 30.2 are produced in the same way and connected to one another by a peripheral seam 2, like the inner housing parts 10.4, 20.4. Pipe connectors 13, 23 are provided on the cones 11, 21.

While specific embodiments of the invention have been shown and described in detail to illustrate the inventive principles, it will be understood that the invention may be embodied otherwise without departing from such principles.

What is claimed is:

1. A housing for an exhaust gas catalyst in motor vehicles with an internal combustion engine, the housing comprising:
a first seamless housing part deep-drawn of sheet metal;
the first seamless housing part comprising at least one inlet cone, at least one first pipe connector, and at least one first cylindrical housing mantle;
a second seamless housing part deep-drawn of sheet metal;
the second seamless housing part comprising at least one outlet cone, at least one second pipe connector, and at least one second cylindrical housing mantle;
the first and second housing mantles connected to one another by a gas-tight peripheral connecting seam.

2. The housing according to claim 1, wherein the first housing part has a cross-section outside of the area of the connecting seam that is different from a cross-section of the second housing part outside of the area of the connecting seam.

3. The housing according to claim 1, wherein at least one of the first and second housing parts has a stepped cylindrical cross-section.

4. The housing according to claim 1, wherein the inlet cones has several of the first pipe connectors.

5. The housing according to claim 1, wherein at least one of the first and second pipe connectors has an axis positioned at an angle to an axis of the first or second housing mantle, respectively.

6. The housing according to claim 1, wherein the first and second pipe connectors have any type of cross-section.

7. The housing according to claim 1, wherein the inlet cone and the outlet cone do not have radial symmetry.

8. The housing according to claim 1, wherein at least one of the inlet cone and the outlet cone has a formed part configured to deflect an exhaust gas flow.

9. The housing according to claim 1, comprising at least one sensor connecting socket formed in one of the first and second housing parts in the area of the connecting seam.

10. The housing according to claim 1, comprising an intermediate member inserted between the first and second housing parts.

11. The housing according to claim 1, comprising an outer housing comprised of at least two deep-drawn outer housing parts and enclosing the first and second housing parts, wherein the at least two outer housing parts are connected by a peripheral outer connecting seam.

12. The housing according to claim 1, wherein the sheet metal is stainless steel.

13. The housing according to claim 1, wherein the sheet metal is Inconel®.
